(19) United States
(12) Patent Application Publication
(10) Pub. No.: US 2024/0169842 A1
(43) Pub. Date: May 23, 2024

(54) METHOD AND CONTROL DEVICE FOR OPERATING A MOTORCYCLE IN A FORMATION OF MOTORCYCLES

(71) Applicant: Robert Bosch GmbH, Stuttgart (DE)

(72) Inventors: Daniel Moriarty, Glenroy (AU); Lars Pfau, Yokohama (JP); Simeon Bain, Montmorency (AU)

(21) Appl. No.: 18/513,065

(22) Filed: Nov. 17, 2023

(30) Foreign Application Priority Data
Nov. 23, 2022 (DE) 102022212489.8

(51) Int. Cl. G08G 1/00; B62J 50/22

(52) U.S. Cl. CPC G08G 1/22; B62J 50/22

(57) ABSTRACT

A method for operating a motorcycle in a formation of motorcycles. Vehicles are detected in a rear area behind the motorcycle and a formation membership of the detected vehicles in the formation is determined. Rear-area information is provided for a driver of the motorcycle via a human-machine interface of the motorcycle. The rear-area information describes the formation membership for at least one of the detected vehicles.

### FIELD

The present invention relates to a method for operating a motorcycle in a formation of motorcycles, to a corresponding control device and to a corresponding computer program product.

### BACKGROUND INFORMATION

Motorcyclists can ride as a group in a formation. In the formation, the motorcycles drive alongside one another in two staggered lines. In this case, the individual motorcyclist orients themselves essentially by the motorcycle driving ahead of them in the line and by the motorcycle driving obliquely ahead of them in the other line.

The motorcyclist riding at the head of the formation may perform a guiding role in the formation as they can determine a route to be ridden. While they are driving ahead, they can perceive the rest of the formation essentially only via their rearview mirrors. A radiotelephone connection to one or more formation members can thereby simplify the exchange of information.

### SUMMARY

The present invention provides a method for operating a motorcycle in a formation of motorcycles, a corresponding control device, and also a corresponding computer program product. Advantageous developments and improvements of the present invention emerge from the disclosure herein.

In the approach presented here according to the present invention, information about vehicles traveling behind a motorcycle is provided for a driver of the motorcycle. In particular, the driver is informed as to whether a vehicle driving behind their motorcycle is part of their formation or is a third-party vehicle not belonging to the formation.

By means of the approach presented here according to the present invention, for example, a leader of a formation of motorcyclists can receive information about the formation driving behind them without having to continuously monitor the formation via their rearview mirrors.

According to an example embodiment of the present invention, a method for operating a motorcycle in a formation of motorcycles is provided, wherein vehicles in a rear area behind the motorcycle are detected, and a formation membership of the detected vehicles in the formation is determined, wherein rear-area information is provided for a driver of the motorcycle via a human-machine interface of the motorcycle, wherein the rear-area information describes the formation membership for at least one of the detected vehicles.

Ideas for embodiments of the present invention may be considered, inter alia, as being based on the concepts and findings described below.

A vehicle can be a car, truck, or a motorcycle or quad bike. A rear area can extend behind the motorcycle. The rear area can also extend laterally to the right and left behind the motorcycle. Vehicles behind the motorcycle can be detected using a rearwardly-directed sensor system of the motorcycle. The sensor system can comprise at least one sensor whose detection region at least partially covers the rear area. The sensor system can also comprise a plurality of sensors. Detection regions of the sensors can overlap. The sensors can have identical or different detection principles. For example, a camera sensor, a radar sensor, a lidar sensor, an ultrasonic sensor or the like can be used as the sensor. Rear-area information can be automatically detected using the sensor system.

A formation of motorcycles can consist of at least two motorcycles. The motorcycles in the formation usually drive in the same lane. In this case, the motorcycles drive relative to one another with a longitudinal offset and a lateral offset. This results in the typical appearance of the formation as a zigzag line.

Another formation which is driven especially in the USA is two or sometimes three motorcycles side by side on the same level in one lane. In some cases, it may be that the motorcycles drive in a line.

A detected vehicle may or may not be a member of the formation. In particular, motorcycles may be members of the formation. Whether the vehicle is a member of the formation can be detected by using a recognition algorithm of the motorcycle. According to an example embodiment of the present invention, the recognition algorithm can evaluate object features of the detected vehicles. The recognition algorithm can output whether the vehicle is classified as belonging or not belonging. The recognition algorithm can calculate a probability of formation membership. If the probability exceeds a threshold value, the vehicle will be recognized as belonging to the formation. For example, the threshold value can be 50%.

For example, a movement pattern of the vehicle can be evaluated in order to detect whether the vehicle belongs to the formation. In the case of a plurality of vehicles, a relative arrangement of the vehicles with respect to one another can be evaluated in order to ascertain formation membership. The recognition algorithm can be executed in a control device of the motorcycle.

A human-machine interface can be a visual, haptic and/or acoustic interface. According to an example embodiment of the present invention, the human-machine interface can provide information for a driver of the motorcycle. The human-machine interface can also convert inputs of the driver into electrical signals and provide them for the executing control device.

According to an example embodiment of the present invention, the human-machine interface can, for example, comprise a graphical display device. The human-machine interface can have pushbuttons and/or switches or touchpads and/or buttons. The human-machine interface can, for example, be integrated into a head-up display or cockpit of the motorcycle. The human-machine interface can also be arranged on a handlebar of the motorcycle. In this case, signal lights on the handlebar for providing the rear-area information can, for example, light up or flash and/or change color.

According to an example embodiment of the present invention, confirmation or rejection of formation membership can be read in via the human-machine interface. The driver can thus change a status, detected by the recognition algorithm, of a vehicle. If the recognition algorithm incorrectly recognizes the vehicle as belonging to the formation, the driver can then remove the vehicle from the formation. Conversely, the driver can add a vehicle that had been incorrectly recognized as not belonging to the formation to the formation.

The rear-area information can furthermore represent a relative position of the at least one vehicle to the motorcycle. The relative position can be represented by numbers and/or symbols. For example, a side of the motorcycle on which the vehicle is located can be marked. In this case, it is possible to distinguish whether the vehicle is located on the right or left behind the motorcycle. By means of just two display options, the rear-area information can be captured quickly and reliably. Likewise, the vehicle in the region of a predefined position in an idealized formation can be displayed.

An angle between a longitudinal axis of the motorcycle and the detected vehicle and/or a distance between the motorcycle and the detected vehicle can also be displayed as rear-area information. The angle can be represented, for example, as an angular section or sector or arrow with a corresponding direction. The distance can be represented as a numerical value. The distance can also be represented as a length of the symbol representing the angle.

According to an example embodiment of the present invention, the rear-area information can be provided in response to a request of the driver that is read in via the human-machine interface. Normally, so as not to distract the driver, rear-area information may not be provided. The rear-area information can be provided when the driver wants to obtain this information. The rear-area information can also only be provided in predetermined driving situations. For example, the rear-area information can be provided below a predetermined speed. Inputs of the driver via the human-machine interface can also be made while stationary, for example at a traffic light.

According to an example embodiment of the present invention, formation membership can be mapped using color coding. A vehicle belonging to the formation can be represented by a different color and/or a different or changed symbol from a vehicle not belonging to the formation.

The method according to the present invention is preferably computer-implemented and can be implemented, for example, in software or hardware or in a mixed form of software and hardware, for example in a driver assistance system.

The approach presented here according to the present invention may furthermore provide a control device in the form of a driver assistance system for a vehicle, wherein the driver assistance system is designed to carry out, control or implement, in corresponding apparatuses, the steps of a variant of the method presented here.

The control device or driver assistance system can be an electrical device having at least one computing unit for processing signals or data, at least one memory unit for storing signals or data, and at least one interface and/or one communication interface for reading in or outputting data embedded in a communication protocol. The computing unit can, for example, be a signal processor, a so-called ASIC system, or a microcontroller for processing sensor signals and outputting data signals on the basis of the sensor signals. The memory unit can, for example, be a flash memory, an EPROM, or a magnetic memory unit. The interface can be designed as a sensor interface for reading in the sensor signals from a sensor and/or as an actuator interface for outputting the data signals and/or control signals to an actuator. The communication interface can be designed to read in or output the data in a wireless and/or wired manner. The interfaces may also be software modules that are present, for example, on a microcontroller in addition to other software modules.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to any one of the embodiments of the present invention described herein is advantageous as well, in particular when the program product or program is executed on a computer or a device.

It is pointed out that some of the possible features and advantages of the present invention are described herein with reference to different embodiments. A person skilled in the art recognizes that the features of the control device and of the method can be suitably combined, adapted, or replaced in order to arrive at further embodiments of the present invention.

### BRIEF DESCRIPTION OF THE DRAWINGS

Embodiments of the present invention are described below with reference to the figures, and neither the figures nor the description should be construed as limiting the present invention.

FIG. 1 shows a graphical representation of rear-area information for use in a method according to an exemplary embodiment of the present invention.

FIG. 2 shows a representation of simplified rear-area information for use in a method according to an exemplary embodiment of the present invention.

FIG. 3 shows an alternative representation of rear-area information for use in a method according to an exemplary embodiment of the present invention.

FIG. 4 shows a representation of rear-area information displayed on the handlebar for use in a method according to an exemplary embodiment of the present invention.

The figures are merely schematic and not true to scale. Identical reference signs refer to identical or identically acting features.

### DETAILED DESCRIPTION OF EXAMPLE EMBODIMENTS

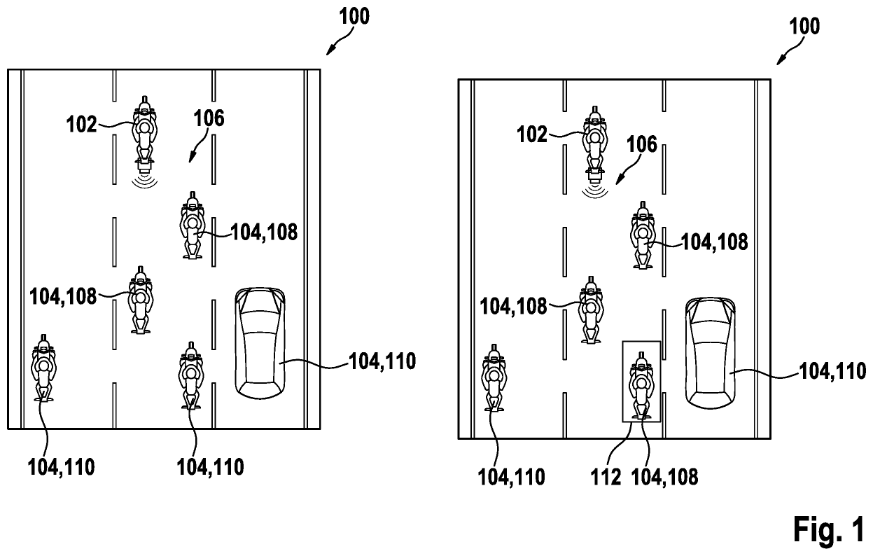

FIG. 1 shows a graphical representation of rear-area information 100 for use in a method according to an exemplary embodiment. The rear-area information 100 is shown as a bird's eye view of a section of road being driven by a motorcycle 102. The rear-area information 100 is provided to a driver of the motorcycle 102 via a human-machine interface. The rear-area information 100 can, for example, be displayed on a screen or a head-up display of the motorcycle 102.

Vehicles 104 which have been detected in a rear area behind the motorcycle 100 by a sensor system of the motorcycle 102 are shown in the rear-area information 100. Some of the vehicles 104 belong to a formation 106 of the motorcycle 102. Shown here behind the motorcycle 102 are four further motorcycles and a car. Three of the motorcycles are driving in the same lane as the motorcycle 102. A further motorcycle is driving in an adjacent lane and the car is driving in a further adjacent lane.

A recognition algorithm of the motorcycle 102 has assigned a formation membership in the formation 106 to the detected vehicles 104 in each case. The formation membership is represented in the rear-area information 100 by color coding of the vehicles 104. Two of the motorcycles driving in the same lane are marked as belonging 108 to the formation. The motorcycle driving in the adjacent lane and the car are marked as not belonging 110 to the formation.

In an exemplary embodiment, a driver of the motorcycle 102 can change the status of the vehicles 104 shown. For this purpose, they select the desired vehicle 104 via an operating element of the motorcycle 102. The selected vehicle 104 is thereby highlighted by highlighting 112. Via an input into the operating element, the driver can now change the formation membership.

Here, the third motorcycle in the lane of the motorcycle 102 is incorrectly marked as not belonging 110. For this reason, the driver therefore has selected this motorcycle and can now set the formation membership to belonging 108.

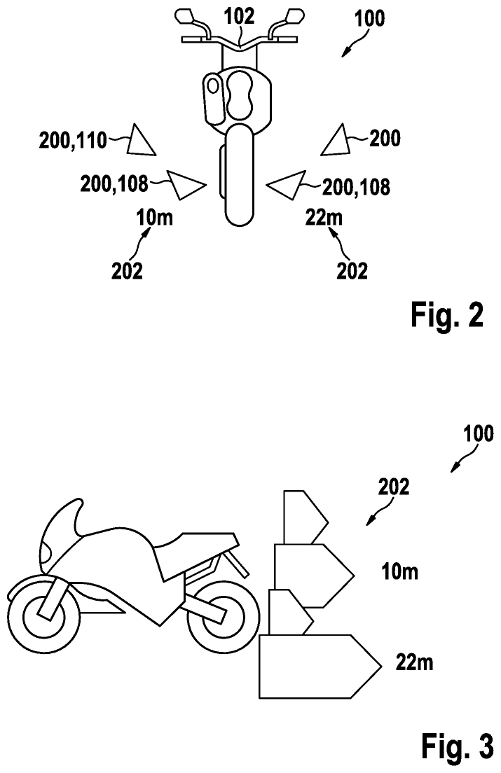

FIG. 2 shows a representation of simplified rear-area information 100 according to one exemplary embodiment. The motorcycle 102 is shown here with four predefined directional pointers 200 in the form of triangles. The four directional pointers 200 in each case represent two angular ranges on the right and left behind the motorcycle 102. A base of the respective triangle points toward the motorcycle and a tip of the triangle points in the direction of the angular range. Via their color, the directional pointers 200 indicate the presence of a vehicle in this angular range and also the formation membership.

In this case, a vehicle is displayed as belonging 108 by two of the directional pointers 200. The directional pointers for member vehicles are shown in blue. One of the directional pointers 200 shows a not-belonging 110 vehicle. The directional pointer 200 to the not-belonging vehicle is shown in green. The fourth directional pointer 200 does not indicate a vehicle. This directional pointer 200 is shown in gray.

In an exemplary embodiment, as rear-area information 100 a distance indication 202 is shown below the directional pointers 200 to the belonging vehicles. The distance indication 202 is a numerical value. Here, the belonging vehicle on the right is 22 meters away. Here, the belonging vehicle on the left is 10 meters away.

FIG. 3 shows an alternative representation of rear-area information 100 according to an exemplary embodiment. The representation substantially corresponds to the representation in FIG. 2. In contrast thereto, only distance indications 202 and no directional pointers are shown here. The distance indications 202 are shown here in the form of arrows. A length of the arrows corresponds to the distance indication 202. As in FIG. 3, formation membership is indicated by the color of the arrow. The distance to a belonging 108 vehicle is shown by a blue arrow.

In an exemplary embodiment, as in FIG. 2, the distance indications 202 are additionally shown as numerical values. As in FIG. 2, two belonging vehicles at distances of 10 and 22 meters are displayed.

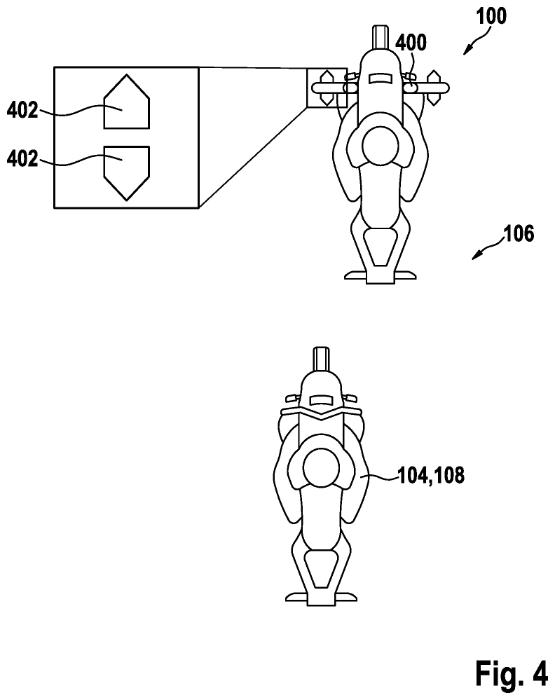

FIG. 4 shows a representation of rear-area information 100 displayed on the handlebar 400 according to an exemplary embodiment. In order to display the rear-area information 100, the handlebar 400 as a human-machine interface has, on the right-hand and left-hand ends, at least one illuminated button 402. The button 402 can be illuminated in different colors. As in FIGS. 2 and 3, the colors represent color coding. Here, the rear-area information 100 is provided via the right-hand button 402 when a vehicle 104 is detected on the right behind the motorcycle 102. Correspondingly, the rear-area information 100 is provided via the left-hand button 402 when a vehicle 104 is detected on the left behind the motorcycle 102. Here, the vehicle 104 is on the left behind the motorcycle 102 and classified as a vehicle 108 belonging to the formation 106. Accordingly, the left-hand button 402 is here illuminated in blue.

In an exemplary embodiment, two buttons 402 are arranged as a rocker switch on each end of the handlebar 400. The driver can thus change or confirm the status of the displayed vehicle 104 via the buttons. A long pressure on one of the buttons is required to change the status. The human-machine interface then switches to a change mode and signals this via a color change. Here one of the keys 402 changes to yellow. The status can then be set by pressing the button. A renewed long pressure on one of the buttons 402 confirms the status change and switches back into a display mode.

Possible embodiments of the present invention are summarized again below or described using slightly different words.

Rearward-object selection for two-wheeled vehicles during group travel is presented.

The approach presented here can be used for a group driving function (GRA) for two-wheeled vehicles. The purpose is driver selection and marking of rearward objects as members/part of a group driving formation. The approach presented improves the driver's understanding of driving information and the world by enabling the driver to interact with a rear sensor in order to improve the driving experience. In particular, the driver can help to select or deselect rearward objects when a driver is driving in a column with rearward objects, e.g. during a group travel mode.

To carry out the approach presented here, the two-wheeler has one or more rearwardly directed sensors for detecting objects behind the two-wheeler, a module for detecting group travel by using the rear sensor and a human-machine interface that enables interaction with the rear sensor in order to improve the driving experience, especially when a driver is driving in a column that has rearward objects as part of the column (e.g., in group travel mode).

The human-machine interface offers the possibility of coordinating the selection, confirmation and display of vehicles in the rearward formation. The human-machine interface enables the display of rearward formation vehicles and/or non-formation vehicles and their attributes so that the driver can select or set these as objects in or outside the formation. The human-machine interface also enables the driver to select and deselect objects in the column and activates/deactivates the selection method, e.g., automatic selection by the sensor or manual selection by the driver.

The module for detecting group travel is provided by the rear sensor or otherwise. The module for detecting group travel automatically detects rearward objects from which it assumes that they are part of a formation, and passes this information on to the human-machine interface. It also marks the object and stores it in the system so that other on-board or connected motorcycle systems can also know that this object is part of the driving formation. The human-machine interface then shows the driver an indication so that they can understand the current condition of the objects and the column.

In the approach presented here, it is indicated to the driver that there are one or more rearward objects that belong to the column (formation). Information regarding the location, the physical properties, the status and/or the general nature of one or more currently selected and/or currently non-selected objects is displayed. Alternatively or additionally, information regarding status, type, configuration, and/or the general nature of the column is also displayed.

The automatic selection or deselection of objects for the display can be configured differently.

In an exemplary embodiment, a rearward object is automatically selected by the sensor, and this object (or details of the object) is displayed to the driver either permanently or non-permanently. It is removed from the display or changed if the sensor determines that it is no longer part of the column. And added/changed if the sensor determines that it does belong.

An object can be automatically deselected if it moves out of the field of view of the sensor or the probability of it existing falls below a certain threshold. The object can also be automatically deselected if the object moves (or is predicted to move) out of a predetermined area or distance setting. The object can also be selected automatically if the recognition algorithm determines on the basis of formation detection criteria that the probability of the object being part of a column has fallen below a threshold. The object can also be automatically deselected if an external condition interrupts the situation or driving mode, e.g., if a sensor error condition is active, the driving situation changes, the vehicle falls below a certain speed, the engine stops, etc.

In the reverse direction, these criteria can be used for an automatic selection.

In a further exemplary embodiment, a rearward object is automatically selected by the sensor and is displayed as In the first exemplary embodiment. An input is then requested from the driver to confirm or reject an automatically selected or deselected rearward object as part of the column.

The selection or deselection of objects for the display can also be done manually. During manual selection, the rearward objects are detected by the sensor and, as indicated in the first embodiment, either permanently or only at the request of the driver. The driver who then wishes to manually select which object (s) belong to the column enters inputs into the human-machine interface in order to select the objects that belong to the column and then to confirm them. The driver can repeat the process at any time in order to add further objects, remove objects or change the status of objects or of the column.

The information about the confirmed group travel is transmitted to other systems on the motorcycle, e.g. via CAN, as this information can be useful for other systems on the motorcycle.

In FIG. 1, the objects are displayed in a bird's eye view, and the driver selects the object that they would like to set. In this case, objects not located in the column are also displayed. The driver can select the object via human-machine interface. Objects in the column can also be automatically selected by the system.

FIG. 2 shows an alternative display and selection strategy for the human-machine interface with arrow indicators that change their color or type, depending on whether a marked (information) object exists in this direction and how far away it is.

FIG. 3 shows a further display and selection strategy for the human-machine interface with bars which change their color when an object is detected in a specific lateral region. The beams shrink or grow depending on the longitudinal distance of the object relative to the motorcycle.

FIG. 4 shows a human-machine interface based on buttons/LEDs. This approach can also be implemented with virtual buttons or indicator lights on a head-up display. In this case, a color and/or a flashing of a button indicates the status of an object on this side in order to give the driver information about the object/status. For example, the rearwardly-directed button flashes to indicate to the driver that the object is being selected. The driver presses the button for a long time in order to cancel.

Finally, it should be pointed out that terms like “having,” “comprising,” etc. do not exclude other elements or steps and terms like “a” or “an” do not exclude a plurality. Reference signs herein are not to be considered as limiting.

1-10. (canceled)

11. A method for operating a motorcycle in a formation of motorcycles, the method comprising the following steps:
detecting vehicles in a rear area behind the motorcycle;
determining a formation membership of the detected vehicles in the formation; and
providing rear-area information for a driver of the motorcycle via a human-machine interface of the motorcycle, wherein the rear-area information describes the formation membership for at least one of the detected vehicles.

12. The method according to claim 11, wherein a confirmation or rejection of the formation membership is read in via the human-machine interface.

13. The method according to claim 11, wherein the rear-area information further represents a relative position of the at least one vehicle to the motorcycle.

14. The method according to claim 13, wherein a side of the motorcycle on which the vehicle is located is marked as the relative position.

15. The method according to claim 13, wherein a distance to the vehicle is displayed as the relative position.

16. The method according to claim 11, wherein the rear-area information is provided to the driver in response to a request of the driver that is read in via the human-machine interface.

17. The method according to claim 11, wherein the formation membership is mapped using color coding and/or a changed symbol.

18. A control device for operating a motorcycle in a formation of motorcycles, the control device configured to:
detect vehicles in a rear area behind the motorcycle;
determine a formation membership of the detected vehicles in the formation; and
provide rear-area information for a driver of the motorcycle via a human-machine interface of the motorcycle, wherein the rear-area information describes the formation membership for at least one of the detected vehicles.

19. A non-transitory machine-readable storage medium on which is stored a computer program for operating a motorcycle in a formation of motorcycles, the computer program, when executed by a processor, causing the processor to perform the following steps:
detecting vehicles in a rear area behind the motorcycle;
determining a formation membership of the detected vehicles in the formation; and
providing rear-area information for a driver of the motorcycle via a human-machine interface of the motorcycle, wherein the rear-area information describes the formation membership for at least one of the detected vehicles.
